(19) United States
(12) Patent Application Publication
(10) Pub. No.: US 2015/0129115 A1
(43) Pub. Date: May 14, 2015

(54) Method For Production of Structure Composite Truss Frame Products by Three-Dimensional Malleable Molds

(71) Applicant: Metin BOLCE, Longview, TX (US)

(72) Inventor: Metin BOLCE, Longview, TX (US)

(21) Appl. No.: 14/535,153

(22) Filed: Nov. 6, 2014

(30) Foreign Application Priority Data
Nov. 8, 2013 (TR) 201312996

(51) Int. Cl. B32B 37/00; B32B 37/10; B32B 38/00; B32B 37/20

(52) U.S. Cl. CPC B32B 37/0046; B32B 37/20; B32B 37/1018; B32B 38/00; B32B 2038/0052; B32B 2250/20; B32B 2260/021; B32B 2260/046; B32B 2305/10; B32B 2313/04
USPC 156/148; 156/180

(57) ABSTRACT

Some embodiments relate to three-dimensional molds and methods of forming such molds. A mold can be prepared by combining three-dimensional molds together. Then, a composite material, such as carbon fiber wetted with epoxy or another reinforcement material, is inserted into column gaps and beam holes in the mold. A joint region can be formed by extending the composite material beyond corner combining elements to reach to another edge combining element, which may prevent the necessity of an additional bonding or joining part. A coating part can enclose the composite material in the mold. The mold can be placed into a vacuum bag for vacuuming processing and bonding of the gaps of the composite material (e.g., carbon fiber) with each other and gaps in the mold. A heat treatment can be performed in a furnace. The product can be extracted by melting the mold in which the product is shaped.

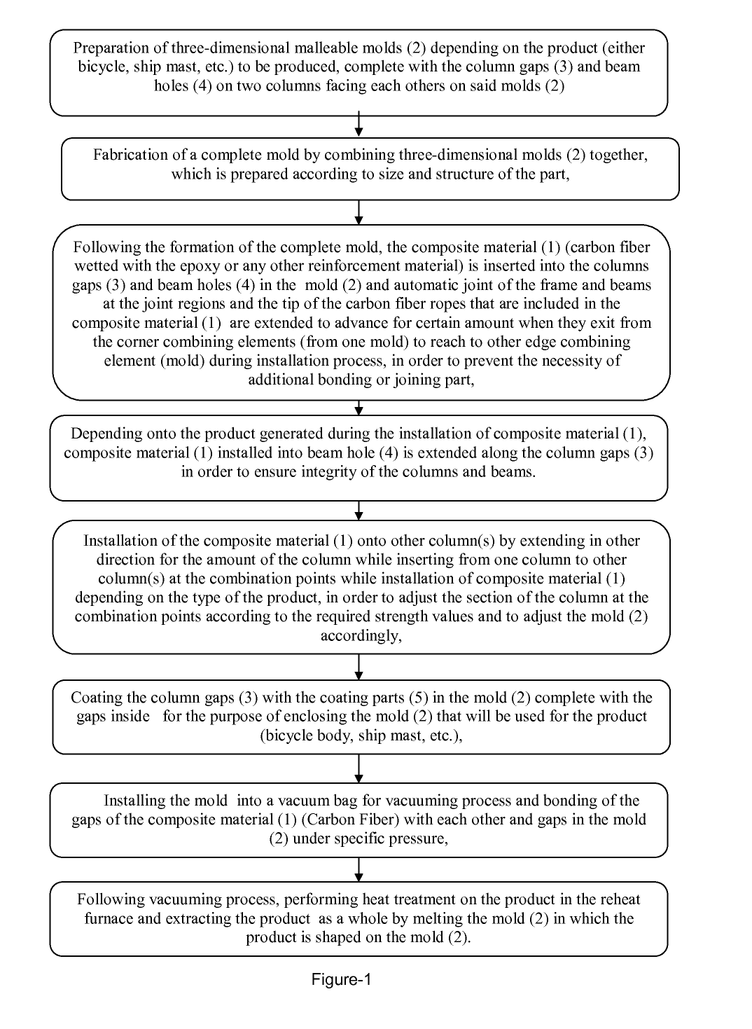

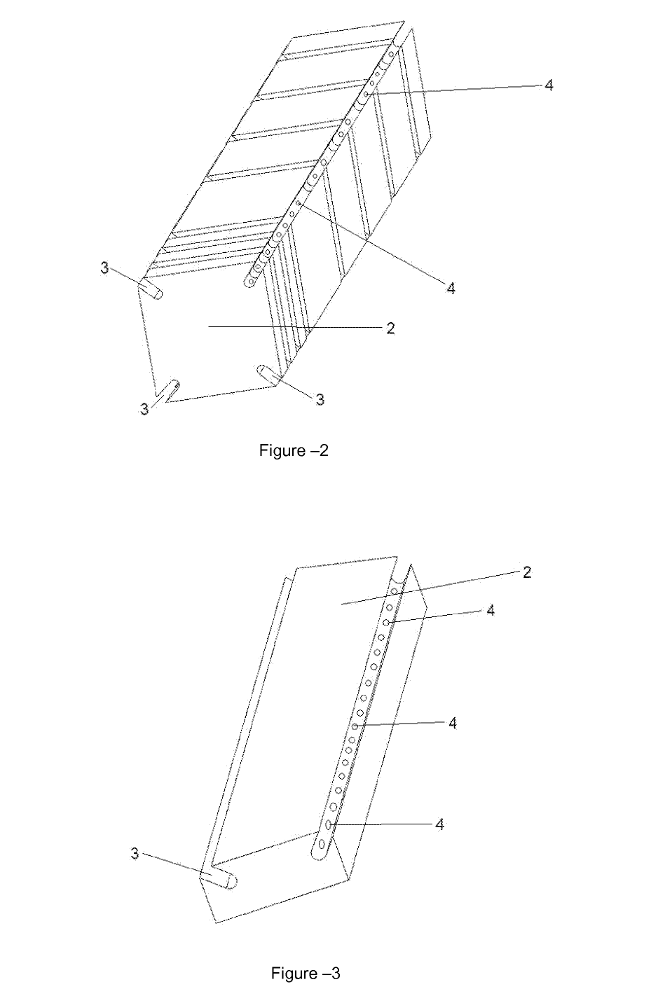

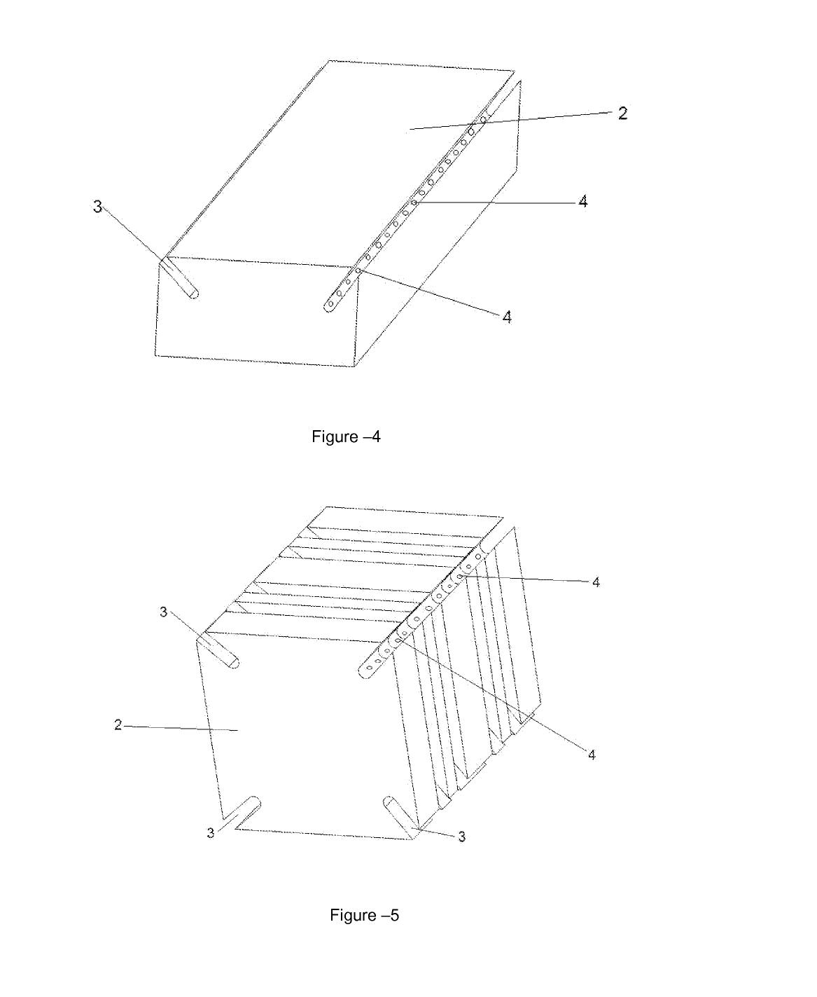

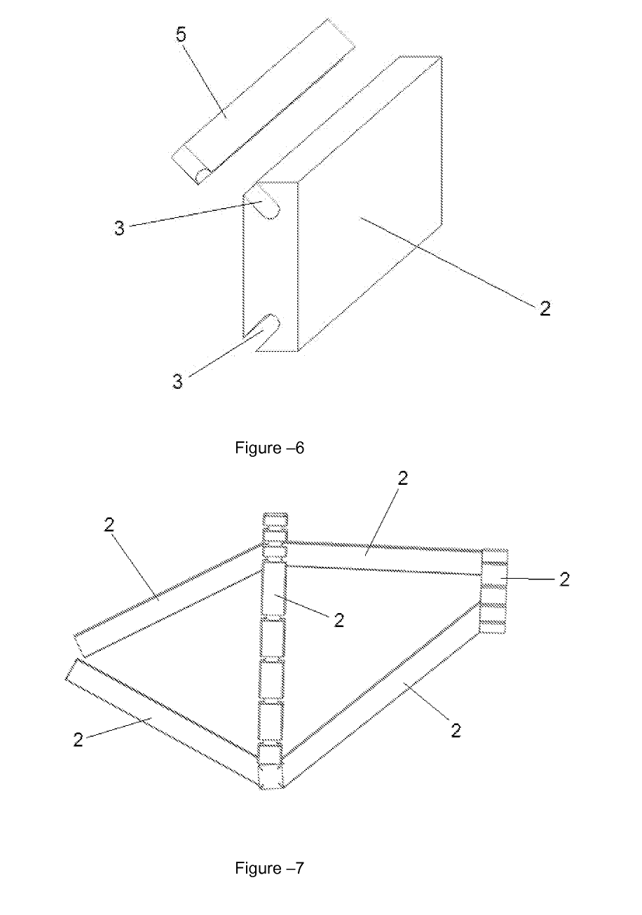

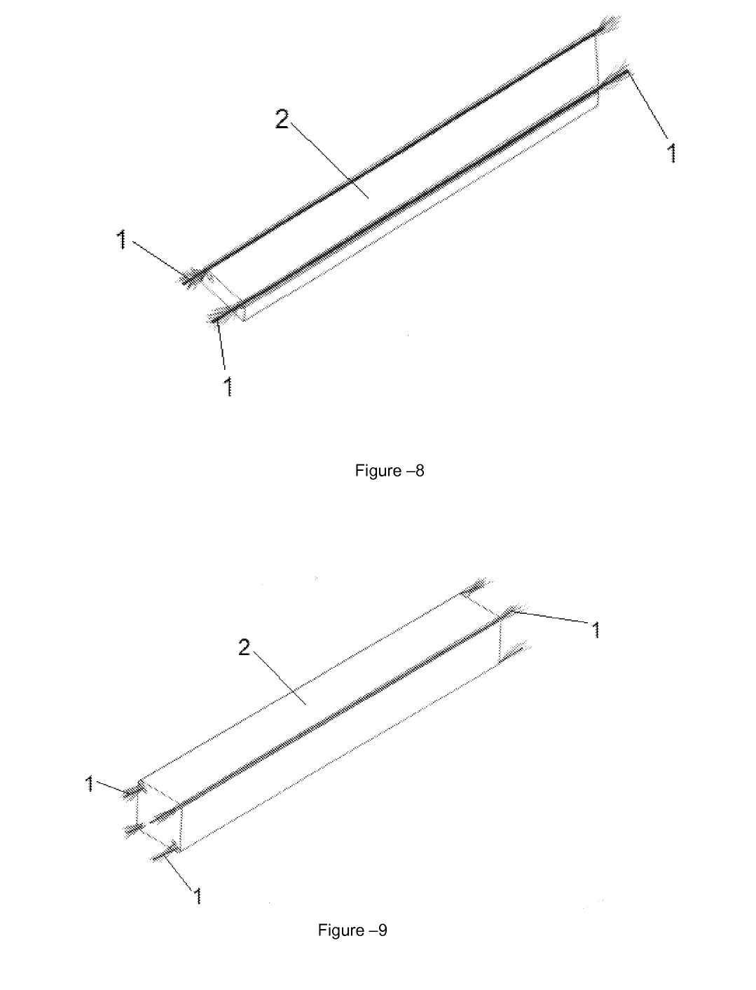

### TECHNICAL AREA

This invention is about production of the bicycle, ship mast, etc. in a monolithic manner in the form of the composite truss frame form by making use of melted three dimensional molds without using joining and bonding materials.

### PREVIOUS ART

The production of the truss frame elements was emerged by the patent applications for truss frames in various forms in 1840s. That method was mostly anticipated for the design of the bridges for the railroads. In general, wood and metal are used, which were specific to the technology at that time. The basic principle here was to strengthen two load-carrying elements by providing the supports in between. Truss frame elements are frequently used in the construction of long load-carrying elements like large hangars and construction cranes. Today, a circular shape of ø20 m (like, for example, round table) is produced in parts by the structural elements in an aluminum truss frame elements.

Again, today the truss frame elements consisted of composite materials are produced in parts that are later on bonded by the structural adhesives. This is an ISO truss production technique patented for the production of the truss frame structures. In this technique, the production isn't performed in the mold; however, a system similar to knitting eight trusses in a machine that inserting one into another, without inserting the trusses into it, which renders its strength limited. Therefore, its strength is limited and thus additional materials should inevitably be used, which gives rise to increase in the weight as well as the costs.

Furthermore, the section of the truss frame element doesn't change varies in the truss method, the direction of the truss thickness, i.e., its angle with the column is constant and product is produced in a straight and rigid manner.

For this reason, conic variable cross-section parts (like downtube in bicycle) cannot be obtained by this method. This limits the product range of the producers.

Furthermore, the structural element produced by making use of this technique, like the bicycle can only be produced by part that is used to combine with another part at the middle of the product. Such a bonding method gives rise to both increase in the weight, as well as limiting the strength of the product with the strength of bonding.

The composite truss structural element is produced by the frame truss connection plate separately and connection points connected with the metal connecting elements. By this way, the producer dragonplate.com company obtained the patent on the rivet connection of the connection region.

Today, for example the bicycle producers follow the production method that ensures the mold installation of the composite material by preparing the expensive materials prepreg (previously soaked composite material) that is wrapped onto the latex material via the latest production method of blowing, then cooling in the cold ambient, replacing latex with the nylon tube and blow the nylon tube with pressurized air in order to ensure insertion of the composite material into the mold. The bicycle part that is produced by the state of the art method of blowing via 350 pieces of prepregs. The joint is something to be avoided and therefore, search is performed for the production by making use of lesser parts, and recently a company claims the production of a bicycle that will be marketed soon made of 70 parts. On the other hand, such method doesn't allow to install the inner truss to cope with high torsional stresses in particular. Again, some bicycle producers perform production about eleven structural elements separately, that are joined by some type of fixing method. That is, a composite structural element is brought together with another part to be coupled with joining. Now, it is common to use unidirectional prepregs in the production of the composites. The most remarkable advantage in using uni-directional prepregs is that it is extremely easy to install the composite material perpendicular to the direction of the force acting on the structural element upon determining the severity and direction of the force acting on the structural element at the design stage (the principle of material located perpendicular to the force acting or principle of carbon fiber made stronger in the direction of the force).

On the other hand, considering inner portion of a hollow element in the form of semi-lunar, it is clear that this isn't proper for obtaining optimum strength). For that reason, it follows that the elements with I-section profile is stronger than that of the hollow elements.

As it is the case for wrapping or extrusion methods, the production of the hollow pipe like an engine propeller or cylindrical part is performed while the product is wrapped onto mandrel in order to ensure uninterrupted production process, resulting the product without supports included in the hollow product. There is no internal support obtained in this method. Whereas, the combination of two elements apart from each other at a specific distance and combined via third part in between gives rise to increase in the resistance to bending thirty-seven time as much.

It is known that the composite materials are consisted of a reinforcements and bonding polymer. The supplementary materials are composed of fine cloth knitted to resume the shape of the surface it is wrapped. On the other hand, it is likely to come across to the carbon fiber, aramid and glass fiber knitted like a sock. In particular special looms are developed for carbon and aramid in particular, where the threads on an x/y plane arranged along x and y direction, consideration is made for the introducing the threads along the direction 45 degree to x and y directions (quadruple weaving). Further step is made to produce looms that operates in the direction of the thickness of the clothes.

In addition to the dry double-direction reinforcing material, it is possible to see unidirectional clothes. The unidirectional reinforcing materials are soaked with polymers and mostly by epoxy to convert these into composite materials, so called prepreg by keeping in cold ambient. By this way, it is possible to bond with other materials containing epoxy materials in paste form. Hundreds of uni-directional prepregs are installed into the mold in various direction, form and coats in parts in order to increase the rigidity of the product that are subject to the vacuum or pressure upon after specific thickness is reached.

Many bicycle producers still perform the production by joining the main pipe elements produced in a separate mold before joining them at their joints. This gives rise to decrease in the strength, increase the weight of the product, extend the fabrication and installation period and reduction in overall productivity and thus increase in the cost due to the reasons cited above, reducing the product's competitive power.

### PURPOSE OF INVENTION

Producing of the trussed-frame structural elements without any joint at the connection points instead of truss frame structures whose connection points bonded at one point or mechanically connected (also for the purpose of obtaining lighter structures, since production is made without joint),

Using jointless carbon fiber (or any other reinforcement materials) along two supporting points that carries the load applied (jointless and lesser material),

Installing of the truss frame elements between two supporting point in vertical direction of the force freely, making use of the materials as necessary according to the logic of the product and this obtain freedom in design and lightness,

Ensuring sharpening of final form of the composite material that are installed into the mold upon drying, irrespective how complex the form of the product is, or whether separate molds are designed for the main part of the product,

Producing a truss frame element like round table, in addition to obtaining flat surfaces, i.e., ensuring production of the complex shapes in the production method of truss frame structure,

Ensuring the production method by separating the components to a certain distance which are connected via supports in between and thus to strengthen the structural hollow elements like ship masts and engine propeller shafts complete with internal supports and thus featuring high strength,

Producing the complex products like bicycle, in one peace and lighter, thanks to the advantages listed above,

Production of stronger and lighter truss frame elements that provide the shapes of the products like airplane wing and fuselage, with the carbon fiber reinforced frameworks,

Producing robust extension elements like robot arms and camera extensions that are required to be flexible without additional elements, and

Removing the adhesives, connection elements, etc. for the installation and preventing the time and labor spent for nothing.

### DESCRIPTION OF FIGURES

1—Work flow diagram

2—Schematic view of the bicycle part mold

3—Schematic view of bicycle part mold (for different part)

4—Schematic view of bicycle part mold (for different part)

5—Schematic view of bicycle part mold (for different part)

6—Combination view of closure part and mold

7—View of assembled molds

8—Schematic view of the bicycle element complete with composite material

9—Schematic view of the bicycle element complete with composite material (different part)

### DESCRIPTION OF REFERENCES IN FIGURES

1—Composite material (carbon fiber)
2—Mold
3—Column gap
4—Beam gap (beam hole)
5—Closing part

### DESCRIPTION OF INVENTION

Description of the terms used in the production method of the subject of this invention,

Composite material (1) is a type of material that is produced by bringing two or more separate materials in a macroscopic manner. Any composite material is generally composed of two type of substances: matrix and reinforcing material. These materials feature different physical properties and composite material obtained by combining the two gives rise to the emergence of difference properties. In general the reinforcement material assumes the task of supporting structure, whereas the matrix phase that surround it (epoxies feature highest properties) hold together and reinforces it.

The woven cloth is most common reinforcement material. The threads woven transversal and longitudinal directions provides strong structure in two directions while passing over and under each other. Furthermore, the threads laid down in forty five degree to these provide the cloth to be strong in each one of four directions.

It is possible to encounter to the reinforcement materials for the production of diverse decorative products without joints. To this and, the baseball stick might be coated by such a reinforcement material to make it wrap its every point on the surface to provide further reinforcement on the stick.

The column is a rigid (solid) structure with specific sectional area, extending to a specific section. The column may not necessarily be straight; it may contain straight composite materials that are woven into each other, together with partial sections wrapping it. Furthermore, it is possible to see the column consisted of group of composites featuring different properties.

The beam is a supporting element complete with a specific sectional area, stretching in straight directions horizontally to support two columns, connecting to the columns at vertical or inclined manner, combining with composite material inside the column. In the production method of this invention, there are three-dimensional molds (2) made of liquefiable materials. These molds are complete with the columns gaps (3) and beam holes (4) on two columns facing each other. The production method of this invention is distinguished with the three-dimensional molds (2) prepared with respect to the product (either bicycle, ship mast, etc.) to be produced, complete with the column gaps (3) and beam holes (4) on two columns facing each other. Three-dimensional molds (2) that are prepared are brought together to form the mold as a unit. Following these operations, the composite material (carbon fiber wetted with the epoxy or any other reinforcement material) (1) is inserted into the columns gaps (3) in the mold (2) and beam holes (4) and the tip of the carbon fiber ropes that are included in the composite material (1) are extended to advance for certain amount when they exit from the corner combining elements (from one mold) to reach to other edge combining element (mold) during installation process. By this way, combining of the frames and beams at the combination areas is performed by itself, without using any additional bonding or joining part at all. Depending onto the product generated during the installation of composite material (1), composite material (1) installed into beam hole (4) is extended along the column gaps (3). By this way, the beams are made integral with the columns and beams.

Depending on the product generated by the installation of the composite material (1) the composite material (1) at the joint point of the columns installed onto other column(s) by extending into different directions while passing from one column to the other column(s). By this way, the section of the column at the joints can be adjusted according to requested strength and the mold (2) is formed accordingly. The composite material (1) are combined with the gaps and holes of the columns and beams (3 and 4) via twisting, knitting or wrapping on the molds (1) according to the section of the product to be produced. By this way the strength is increased. The production method of this invention, closing parts (5) complete with the gaps and holes of the column and beams are installed onto the column gaps (3) on the molds (2) and column gaps (3) are completely covered. The product produced by this way by enclosing the composite material (1) installed according to the type of the product (bicycle body, ship mast, etc.). Then the mold (2) is installed into a vacuum bag for vacuuming process and bonding of the gaps of the composite material (1) (carbon fiber) with each other and gaps in the mold (2) under specific pressure.

Finally heath treatment is performed on the product in the reheat furnace and the product is extracted as a whole by melting the mold (2).

1.-3. (canceled)

4. A method comprising:
fabricating a three-dimensional mold by combining multiple, separate molds, the three-dimensional mold having a column gap and a beam gap, the beam gap extending from the column gap; and
forming a three-dimensional product from a composite material by inserting the composite material into the three-dimensional mold, the composite material being inserted into the column gap and the beam gap, a column section being formed in the column gap, a beam section being formed in the beam gap, an integrated joint being formed where the column section meets the beam section.

5. The method of claim 4, wherein the composite material is carbon fibers wetted with a reinforcement material.

6. The method of claim 5, wherein the reinforcement material is epoxy.

7. The method of claim 4, wherein the forming the three-dimensional product comprises placing the three-dimensional mold into a vacuum bag, the three-dimensional mold and composite material undergoing a vacuum process.

8. The method of claim 4, wherein the forming the three-dimensional product comprises inserting the composite material in the three-dimensional mold into a furnace after inserting the composite material into the three-dimensional mold, the furnace heating the three-dimensional mold.

9. The method of claim 8, wherein the heating the three-dimensional mold includes melting the three-dimensional mold.

10. The method of claim 4, wherein the three-dimensional mold comprises a malleable material.

11. The method of claim 4, wherein the composite material comprises fibers, wherein the inserting the composite material into the three-dimensional mold comprises extending the fibers from the column gap to the beam gap to form at least in part the integrated joint.

12. The method of claim 4, wherein the composite material comprises fibers, wherein the inserting the composite material into the three-dimensional mold comprises bonding the fibers with each other.

13. The method of claim 4, wherein the composite material comprises fibers, wherein the inserting the composite material into the three-dimensional mold comprises twisting, knitting, and/or wrapping the fibers.

14. A method comprising:
inserting carbon fibers into a three-dimensional mold, the carbon fibers extending from a column gap of the three-dimensional mold to a beam gap of the three-dimensional mold at a joint;
bonding the fibers together in the three-dimensional mold; and
heating the three-dimensional mold after the bonding the fibers together.

15. The method of claim 14 further comprising fabricating the three-dimensional mold by combining separate, multiple molds.

16. The method of claim 14, wherein the bonding the fibers together comprises using a vacuum process.

17. The method of claim 14, wherein the heating the three-dimensional mold includes melting the three-dimensional mold.

18. The method of claim 14, wherein carbon fibers are wetted with a reinforcement material.

19. A method comprising:
bringing together multiple molds to form a three-dimensional mold comprising a column hole and a beam hole, the column hole intersecting the beam hole at an angle;
inserting a composite material in the column hole and the beam hole, the composite material comprising carbon fibers, the carbon fibers extending from the column hole into the beam hole;
bonding the carbon fibers together in the three-dimensional mold; and
after the bonding the carbon fibers together, melting the three-dimensional mold.

20. The method of claim 19, wherein the composite material further comprises a reinforcement material.

21. The method of claim 19, wherein the bonding the carbon fibers together comprises using a vacuum process.

22. The method of claim 21, wherein the vacuum process comprises inserting the three-dimensional mold in a vacuum bag.

23. The method of claim 19, wherein the melting the three-dimension mold comprises placing the three-dimensional mold in a furnace, the furnace curing the composite material.
